(19) United States
(12) Patent Application Publication
(10) Pub. No.: US 2024/0373309 A1
(43) Pub. Date: Nov. 7, 2024

(54) Diversity Bluetooth System and Method

(71) Applicant: BRAGI GmbH, München (DE)

(72) Inventor: Luigi Belverato, München (DE)

(73) Assignee: BRAGI GmbH, München (DE)

(21) Appl. No.: 18/774,915

(22) Filed: Jul. 16, 2024

Related U.S. Application Data
(63) Continuation of application No. 18/329,178, filed on Jun. 5, 2023, now Pat. No. 12,052,620.
Application No. 18/329,178 is a continuation of application No. 17/871,044, filed on Jul. 22, 2022, now Pat. No. 11,683,735.
Application No. 17/871,044 is a continuation of application No. 17/368,624, filed on Jul. 6, 2021, now Pat. No. 11,419,026.
Application No. 17/368,624 is a continuation of application No. 15/949,953, filed on Apr. 10, 2018, now Pat. No. 11,064,408.
Application No. 15/949,953 is a continuation of application No. 15/290,811, filed on Oct. 11, 2016, now Pat. No. 9,980,189.
(60) Provisional application No. 62/244,167, filed on Oct. 20, 2015.

(51) Int. Cl. H04W 36/06; H04B 5/00; H04B 7/08; H04R 1/10; H04R 5/033; H04W 4/80; H04W 72/02

(52) U.S. Cl. CPC H04W 36/06; H04B 5/00; H04R 1/1091; H04R 5/033; H04W 4/80; H04W 72/02; H04B 7/08; H04R 2420/07

(57) ABSTRACT

A first device having a transceiver and an antenna operatively connected to the transceiver and a second device having a transceiver and an antenna operatively connected to the transceiver, the first device in operative communication with the first device through a communications linkage separate from the transceiver of the first device and the transceiver of the second device. The first device is adapted to wirelessly communicate with a remote device through the transceiver of the first device. The second device is adapted to wirelessly communicate with the remote device through the transceiver of the second device. The system is configured to evaluate the wireless connection between the first device and the remote device and to evaluate the wireless communication between the second device and the remote device and determine whether the first device or the second device has a better connection.

### PRIORITY STATEMENT

This application is a continuation of U.S. patent application Ser. No. 18/329,178, filed on Jun. 5, 2023 which is a continuation of U.S. patent application Ser. No. 17/871,044, filed on Jul. 22, 2022 and now U.S. Pat. No. 11,683,735 which is a continuation of U.S. patent application Ser. No. 17/368,624, filed on Jul. 6, 2021 and now U.S. Pat. No. 11,419,026 which is a continuation of U.S. patent application Ser. No. 15/949,953, filed on Apr. 10, 2018 and now U.S. Pat. No. 11,064,408 which is a continuation of U.S. patent application Ser. No. 15/290,811, filed on Oct. 11, 2016 and now U.S. Pat. No. 9,980,189 which claims priority to U.S. Provisional Patent Application No. 62/244,167 filed on Oct. 20, 2015, all titled Diversity Bluetooth System and Method, all of which are hereby incorporated by reference in their entireties.

### FIELD OF THE INVENTION

The present invention relates to wearable devices. More particularly, but not exclusively, the present invention relates to ear pieces, wireless headphones and other devices.

### BACKGROUND

Issues with the transmission and reception of Bluetooth signals remain challenging in many situations. Common areas of difficulty involve systems requiring proximity of the communicating entities. There are numerous reasons for such difficulties. Variables such as materials which are impervious to penetration by radio waves at the frequencies used by Bluetooth technology continue to remain problematic. One example of such difficulty involves the use of wireless Bluetooth earpieces.

Depending on the location of the source and the location of the antenna of the earpiece or headphone, a reliable and stable connection might be difficult or impossible, since the body itself of the person wearing the headphones acts as a shield. This is especially notable if the antenna is located on one side of the head, and the source is carried on the opposite side, for example in a trouser, or even a shirt pocket.

Outdoors the connection is made even more difficult due to lack of radio reflecting surfaces (ceiling, close vertical walls, solid floor), so a close to line of sight connection between the communication actors may be needed. What is needed are new systems and methods to address these issues.

### SUMMARY

Therefore, it is a primary object, feature, or advantage of the present invention to improve over the state of the art.

It is a further object, feature, or advantage of the present invention to improve wireless connections in devices such as wearable devices such as ear pieces and head phones which connect wirelessly to other devices.

It is a still further object, feature, or advantage of the present invention to provide for methods and systems maintaining connections even in significantly adverse environments.

Another object, feature, or advantage is to provide for methods and systems suitable to use for audio streaming.

Yet another object, feature, or advantage is to provide for lowering power utilization by creating optimal linkages.

A further object, feature, or advantage is to provide for addressing problems of weak transmissions at an underserved area.

A still further object, feature, or advantage is to provide a solution which allows devices to remain within Bluetooth standards while simultaneously delivering the required connection in the defined adverse environments.

One or more of these and/or other objects, features, or advantages of the present invention will become apparent from the specification and claims following. No single embodiment need provide every object, feature, or advantage. Different embodiments may have different objects, features, or advantages. Therefore, the present invention is not to be limited to or by any objects, features, or advantages stated herein.

According to one aspect a system includes a first device having a transceiver and an antenna operatively connected to the transceiver and a second device having a transceiver and an antenna operatively connected to the transceiver, the first device in operative communication with the first device through a communications linkage separate from the transceiver of the first device and the transceiver of the second device. The first device is adapted to wirelessly communicate with a remote device through the transceiver of the first device. The second device is adapted to wirelessly communicate with the remote device through the transceiver of the second device. The system is configured to evaluate the wireless connection between the first device and the remote device and to evaluate the wireless communication between the second device and the remote device and determine whether the first device or the second device has a better connection and if the first device has the better connection to use the wireless connection between the first device and the remote device and if the second device has the better connection to use the wireless connection between the second device and the remote device. The first device may be a left ear piece and the second device may be a right ear piece. The first device may be a left portion of a headphone set and the second device may be a right portion of the headphone system. The better connection may provide a stronger signal. The transceiver of the first device may be a Bluetooth transceiver and the transceiver of the second device may be a Bluetooth transceiver. The first device may be configured to receive streaming audio of the wireless connection between the first device and the remote device and the second device may be configured to receiving streaming audio of the wireless connection between the second device and the remote device. The communications linkage between the first device and the second device may be a wired linkage. The communications linkage between the first device and the second device may be a near field magnetic inductance (NFMI) wireless linkage. The communications linkage between the first device and the second device may be an ultra-wideband (UWB) wireless linkage. The transceiver of the first device and the transceiver of the second device may share connection data related to connection with the remote device. The transceiver of the first device and the transceiver of the second device may have synchronized protocol stacks. The first device and the second device may each perform signal measurements of signals from the remote device and share the signal measurements there between. The first device and the second device may be configured to coordinate handover of a connection with the remote device. The remote device may be a mobile device configured for communicating streaming audio.

According to another aspect, a system includes a first wearable device having a radio transceiver and an antenna operatively connected to the radio transceiver and a second wearable device having a radio transceiver and an antenna operatively connected to the radio transceiver, the first device in operative communication with the first device through a communications linkage separate from the radio transceiver of the first device and the radio transceiver of the second device. The first wearable device may be adapted to wirelessly communicate with a remote device through the radio transceiver of the first wearable device. The second wearable device may be adapted to wirelessly communicate with the remote device through the radio transceiver of the second wearable device. The first wearable device and the second wearable device may be adapted to perform signal measurements relative to the remote device and share measurement information and perform handovers there between. The first wearable device may be a left ear piece and the second wearable device may be a right ear piece. The first wearable device may be a left portion of a headphone set and the second wearable device may be a right portion of the headphone set.

According to another aspect, a method for improving signal communications is provided. The method includes providing a first wearable device and a second wearable device, monitoring at least one signal parameter associated with a signal communicated between a remote device and a radio transceiver of the first wearable device, monitoring at least one signal parameter between the remote device and a radio transceiver of the second wearable device. The method further includes communicating data between the first wearable device and the second wearable device over a communication channel separate than a communications channel between the radio transceiver of the first wearable device and the radio transceiver of the second wearable device. The method further includes connecting one of the first wearable device and the second wearable device, the one receiving a better signal based on a comparison of the at least one signal parameter associated with the signal communication between the remote device and the radio transceiver of the first wearable device and the at least one signal parameter associated with the signal.

### BRIEF DESCRIPTION OF THE DRAWINGS

FIG. 1 illustrates one example of a system.

FIG. 2 illustrates one example of wearable devices in the form of left and right ear pieces.

FIG. 3 illustrates one example of wearable devices in the form of headphones having left and right portions.

### DETAILED DESCRIPTION

The present invention relates to wearable devices including ear pieces, wireless headphones and other devices, especially where there are multiple wearable devices capable of being in operative communication with a remote device, an external device, or source. Such a remote device may be a mobile device such as a phone or tablet, or other type of computing device. Although various types of devices, wearable devices or personal area devices are contemplated, for purposes of explanation, generally the example of a wireless headphone or a set of wireless earpieces is used. In the case of the headphone, the wireless connection is the connection between the headphone and the external wireless device. The connection between the two earpieces may be wireless or may be a wired connection. A wireless headphone necessitating the use of two radio units would suffice. The headphone or wireless earpiece set comprises two radio units, one per side. The source is bonded to only one of the two radios. The two radios can communicate with each other over a separate channel which is not affected by the same propagation issues. Some examples of this separate channel are the use of UWB, magnetic induction such as NFMI or wired connections. One of the radios behaves in the normal fashion, e.g. it advertises its presence and services to the surrounding environment. The other radio is a clone of the visible one, e.g. if they were visible, they would be indistinguishable from the one the source talks to.

According to one example, coverage of Bluetooth wireless headphones is extended using coordinated radios. The radios in the headphone or earpieces share all the connection data related to the connected source and their protocol stacks can be synchronized. All the radios perform signal measurements in relation to the source and share the measurements information over the out-of-band channel. The radios coordinate among themselves a seamless handover of the connection to the source to achieve the best signal, depending on their position on the body. The radio with the best signal becomes active and takes over the communication from the previously connected radio. A connection can be established and maintained even in more adverse environments. Even in less adverse environments, the advantage of a lower power connection may be utilized.

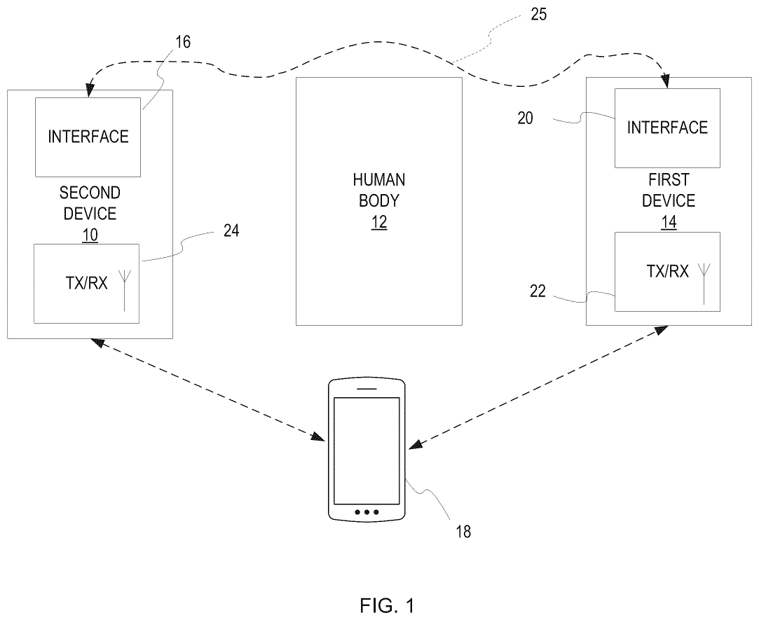

FIG. 1 illustrates one example of a system. As shown in FIG. 1 there is a first device 14 and a second device 10. The first device 14 and the second device 10 may be wearable devices such as ear pieces or portions of a headphone set, or other type of devices. A human body 12 may be situated between the first device 14 and the second device 10. A remote or external device or source 18 is also shown in contact with the first device 14 and the second device 10. Note the remote device 18 may be on one side of the human body 12 or the other side of the human body 12. Thus, for example, where the remote device 18 is a mobile phone, the mobile phone may, for example, be in the left pants pocket of a user or may be in the right pants pocket of the user. The location of the remote device 18 relative to the first device 14 or the second device 10 may adversely affect signal strength which may be problematic in various situations such as where the remote device 18 is sending streaming audio to the first device 14 and/or the second device 10. A transceiver such as a radio transceiver such as a Bluetooth transceiver 22 may be present in the first device 14 and another radio transceiver such as a Bluetooth transceiver 24 may be present in the second device 10. An antenna may be operatively connected to the transceiver 22 of the first device 14 and an antenna may be operatively connected to the transceiver 24 of the second device 10. In addition, the first device has an interface 20 and the second device has an interface 16 which put the first device 14 and the second device 10 in operative communication. The interfaces 16, 20 may be a wireless interface which provide for wireless communications such as through magnetic induction, near field magnetic induction (NFMI), ultra-wideband (UWB) or other types of wireless communications. Alternatively, the interfaces 16, 20 may connect with one another through a wired interface. Thus, the interfaces 16, 20 may provide for a wireless linkage or a wired linkage.

The first device 14 and the second device 10 may both connect to the device 18 and may both analyze the signal from the device 18 such as to determine the strength of the signal. The first device 14 and the second device 10 may then communicate information about the measured signal strength or other signal characteristics through their linkage between interfaces 16, 20 to determine which of the devices is better receiving the signal from the device 18. Thus, the first device 14 and the second device 10 determine which device has a better connection with the device 18 and then use the connection for communications. It is contemplated this may be accomplished in various ways and use one or more signal parameters such as, but not limited to signal strength, signal-to-noise ratio, received signal strength indicator (RSSI), noise, signal quality or other signal measurements or other parameters. In addition, both the first device 14 and the second device 10 may include an intelligent control (not shown) such as one or more processors or controllers which may be used to evaluate signals or may be involved in the switching. Alternatively, this functionality may be accomplished by the transceiver(s) 22, 24.

Both first device 14 and the second device 10 may perform signal measurements in relation to the source associated with the device 18 and share the measurement information over the out-of-band communications channel 25. In addition, radios of the first device and the second device coordinate among themselves such as to provide a seamless handover of the connection to the device 18 or source in order to achieve the best signal. Thus, the radio with the best signal becomes active and takes over communications.

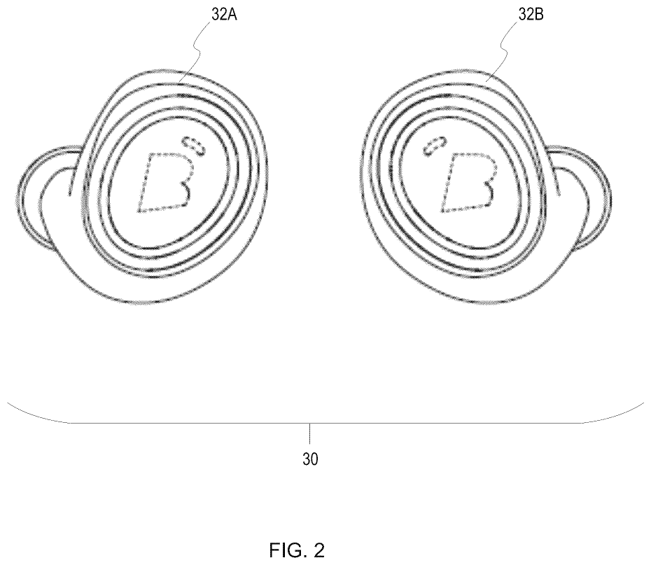

FIG. 2 illustrates a set of ear pieces 30 which include a left device 32A and a right device 32B. In such an embodiment, a wireless linkage may be used to communicate between the left device and the right device. The wireless linkage used is separate from any wireless linkage between the left device or right device and the remote device.

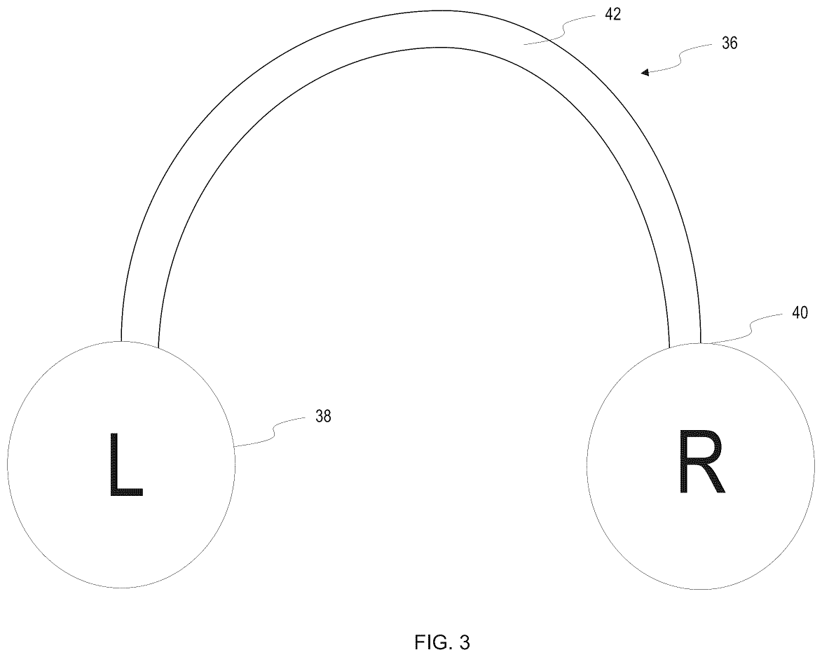

FIG. 3 illustrates a set of headphones 36 with a left device 36 and a right device 40 and a central portion 42 spanning between the left device 36 and the right device 40. In such an embodiment, a wired connection may be used between the left device and the right device, the wire (not shown) traversing the central portion 42.

Although various types of radio transceivers may be used according to various protocols and standards, various embodiments may be implemented consistent with the Bluetooth standard. It is observed a multiuser diversity system would theoretically solve at least some of the problems addressed, but such a system works outside of the Bluetooth standard. Further, it would also be limited since candidate receivers may not always be available. Thus, a universally stable solution is provided herein not requiring cooperation between transmitting device and the location of receiving devices. This is advantageous because Bluetooth cannot implement such a standard; and there are benefits to remaining within the Bluetooth standard to maintain the compatibility of Bluetooth devices support.

It should also be appreciated a connection can be established and maintained even in significantly adverse environments. This is especially important for problematic experiences of using an audio device streaming music while placed in a location unfavorable for stable streaming. One example is the use of an audio streaming device where the receiving unit is present in the right ear, and the audio streaming device is in the user's left pants pocket. In the cited example, the receiving unit would switch from the right side to the left.

It should be further appreciated one of the advantages of various embodiments relates to lower power utilization. Lower power utilization may be achieved, as the linkage is automatically established with the receiving unit in the optimal location for reception of the transmitted signal. One example would be facilitating the ability to link to a receiving unit which moves into a line of sight position.

In addition, advantages over typical antenna diversity solutions is achieved. Antenna diversity increases the level of difficulty of implementation of a proposed solution, while still suffering from the fact no matter how many antennas are hypothesized, physical location in the desired area will still be required. The use of a physical unit at the desired location solves the problem of weak transmission to the underserved area.

The invention is not to be limited to the embodiments described herein. The foregoing description has been presented for purposes of illustration and description. It is not intended to be an exhaustive list or limit any of the invention to the precise forms disclosed. It is contemplated other alternatives or exemplary aspects are considered included in the invention. The description is merely examples of embodiments, processes or methods of the invention. It is understood any other modifications, substitutions, and/or additions can be made, which are within the intended spirit and scope of the invention.

What is claimed is:

1. A system for improving wireless communication comprising:
a first wearable device having a transceiver and an antenna operatively connected to the transceiver;
a second wearable device having a transceiver and an antenna operatively connected to the transceiver;
the first wearable device and the second wearable device being in operative communication through a communication linkage separate from communications between the first and second wearable devices and a remote device;
wherein the first wearable device and the second wearable device are each adapted to wirelessly communicate with the remote device;
wherein the system is configured to evaluate wireless connections between the first wearable device and the remote device and between the second wearable device and the remote device, determine which device has a better connection, and use the better connection for communication with the remote device.

2. The system of claim 1, wherein the first wearable device is a left ear piece and the second wearable device is a right ear piece.

3. The system of claim 1, wherein the communication linkage is a wired linkage.

4. The system of claim 1, wherein the communication linkage is a near field magnetic inductance (NFMI) wireless linkage.

5. The system of claim 1, wherein the communication linkage is an ultra-wideband (UWB) wireless linkage.

6. The system of claim 1, wherein the transceivers of the first and second wearable devices are Bluetooth transceivers.

7. The system of claim 1, wherein the first and second wearable devices share connection data related to the connection with the remote device.

8. The system of claim 1, wherein the first and second wearable devices have synchronized protocol stacks.

9. The system of claim 1, wherein the first and second wearable devices are configured to coordinate handover of a connection with the remote device based on signal strength.

10. A method for improving signal communications between a remote device and a wearable device system comprising:
providing a first wearable device having a transceiver and an antenna operatively connected to the transceiver;
providing a second wearable device having a transceiver and an antenna operatively connected to the transceiver;
monitoring at least one signal parameter associated with a signal communicated between the remote device and the transceiver of the first wearable device;
monitoring at least one signal parameter associated with a signal communicated between the remote device and the transceiver of the second wearable device;
communicating data between the first wearable device and the second wearable device over a communication channel separate from communications between the transceivers of the first and second wearable devices and the remote device;
using the better signal, based on the comparison of the signal parameters, for communication with the remote device.

11. The method of claim 10, wherein the wearable devices are ear pieces.

12. The method of claim 10, wherein the communication channel between the first and second wearable devices is a wired channel.

13. The method of claim 10, wherein the communication channel between the first and second wearable devices is an NFMI wireless channel.

14. The method of claim 10, wherein the communication channel between the first and second wearable devices is a UWB wireless channel.

15. The method of claim 10, wherein the wearable devices are headphones with a left portion and a right portion.

16. The method of claim 10, further comprising the step of sharing signal measurement information between the first and second wearable devices over the communication channel.

17. The method of claim 10, further comprising the step of coordinating handover of the connection with the remote device based on the shared signal measurement information.

18. A system for seamless handover of wireless connections comprising:
a first wearable device having a radio transceiver and an antenna operatively connected to the radio transceiver;
a second wearable device having a radio transceiver and an antenna operatively connected to the radio transceiver;
a communication linkage between the first wearable device and the second wearable device, wherein the linkage is separate from communications between the first and second wearable devices and a remote device;
wherein the first and second wearable devices are adapted to perform signal measurements relative to the remote device, share measurement information, and coordinate handovers based on the signal measurements to maintain an optimal wireless connection with the remote device.

19. The system of claim 18, wherein the wearable devices are ear pieces and the remote device is a mobile phone.

20. The system of claim 18, wherein the wearable devices are headphones, and the communication linkage is a wired connection spanning a central portion between the left and right devices.
